(19) United States
(12) Patent Application Publication
(10) Pub. No.: US 2006/0028776 A1
(43) Pub. Date: Feb. 9, 2006

(54) Electrostatic discharge protection for an integrated circuit

(76) Inventors: Michael Stockinger, Austin, TX (US); James W. Miller, Austin, TX (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/914,442

(22) Filed: Aug. 9, 2004

(51) Int. Cl. H02H 9/00

(52) U.S. Cl. 361/56

(57) ABSTRACT

An ESD protection circuit (40) uses parasitic drain-body diodes (47, 49) of the output buffer transistors (46, 48) as the main, or dominant, ESD protection diodes. Specifically, butted source-body ties in the output buffer transistors (46, 48) provide the ESD diodes (47, 49). Using parasitic drain-body diodes of output buffer transistors with butted source-body ties as the dominant ESD diodes reduces the layout area required to implement the ESD protection circuit as compared to an ESD protection circuit having stand alone diodes. Also, the butted source-body ties reduce susceptibility to latch-up and reduce capacitive loading because there are no added diffusion regions tied to the pad.

### CROSS REFERENCE TO RELATED, COPENDING APPLICATIONS

A related, copending application is entitled “Transient Detection Circuit”, Michael Stockinger et al., application Ser. No. 10/315,796, is assigned to the assignee hereof, and filed on Dec. 10, 2002.

A related, copending application is entitled “Electrostatic Discharge Protection Circuit and Method of Operation”, Michael Stockinger et al., application Ser. No. 10/684,112, is assigned to the assignee hereof, and filed Oct. 10, 2003.

### FIELD OF THE INVENTION

This invention relates generally to electrostatic discharge (ESD) protection for integrated circuits, and more specifically, to an ESD protection circuit that uses parasitic diodes as ESD protection devices.

### BACKGROUND OF THE INVENTION

An integrated circuit (IC) may be subject to an Electrostatic Discharge (ESD) event in the manufacturing process, during assembly and testing, or in the system application. Some on-chip ESD protection networks use an active MOSFET (metal oxide semiconductor field-effect transistor) rail clamp protection scheme with large ESD diodes between the input/output (I/O) pads and the power supply rails.

FIG. 1 illustrates in schematic diagram form a prior art ESD protection circuit 10. ESD protection circuit 10 includes a boost bus labeled “BOOST BUS”, an I/O buffer power supply bus labeled “VDD BUS”, and a ground bus labeled “VSS BUS”. A rail clamp device 12 has current electrodes coupled between the VDD BUS and the VSS BUS. A trigger circuit 14 is coupled between the BOOST BUS and the VSS BUS for providing a trigger signal to the gate of the rail clamp device 12. A diode 24 is coupled between the BOOST BUS and an I/O pad 36, a diode 26 is coupled between the VDD BUS and the I/O pad 36, and a diode 28 is coupled between the I/O pad 36 and the VSS BUS. A diode 30 is coupled between the BOOST BUS and an I/O pad 38, a diode 32 is coupled between the VDD BUS and the I/O pad 38, and a diode 34 is coupled between the I/O pad 38 and the VSS BUS. An integrated circuit may have many I/O pads to protect. CMOS (complementary metal oxide semiconductor) I/O circuits will generally include a PMOS (P-type metal oxide semiconductor) output buffer transistor and an NMOS(N-type metal oxide semiconductor) output buffer transistor coupled to drive an internally generated signal on an I/O pad. In FIG. 1, a PMOS output buffer transistor 16 and an NMOS output buffer transistor 18 are coupled to I/O pad 36. A PMOS output buffer transistor 20 and an NMOS output buffer transistor 22 are coupled to I/O pad 38. The gates of output buffer transistors 16, 18, 20, and 22 receive predriver signals PD.P1, PD.N1, PD.P2, and PD.N2, respectively.

ESD diodes 26, 28, 32, and 34 are sized for conducting a relatively large ESD current. Diode 26 provides a high-current ESD path from the I/O pad 36 to the VDD BUS in case of a positive ESD event on the I/O pad. Diode 28 provides a high-current ESD path from the VSS BUS to I/O pad 36 in case of a negative ESD event on the I/O pad. During an ESD event that requires shunting a high ESD current from the VDD BUS to the VSS BUS by rail clamp device 12, for example a positive ESD zap on I/O pad 36 with respect to I/O pad 38, trigger circuit 14 provides the BOOST BUS voltage to the gate of rail clamp device 12. Diode 24 provides a separate current path from the I/O pad 36 via the BOOST BUS to power trigger circuit 14. Since very little current is required to power trigger circuit 14, the voltage drop across diode 24 during an ESD event is much smaller than the voltage drop across diode 26. In this manner, the BOOST BUS supplies a voltage that is higher than the VDD BUS voltage through the trigger circuit to the gate of rail clamp device 12 during an ESD event, thereby providing increased conductivity of the rail clamp device. The BOOST BUS can be relatively narrow due to the very little current it needs to conduct.

Diodes 24, 26, 28, 30, 32 and 34 are implemented with shallow trench isolation (STI) between the heavily N-doped (N+) active and heavily P-doped (P+) active diffusion regions. These are referred to as STI diodes. Diodes 26, 28, 32 and 34 may be formed from the drain to body (i.e. N-well or P-substrate tie) STI diodes parasitic to output buffer transistors 16, 18, 20 and 22, respectively. However, in many typical output buffer physical layouts, these parasitic STI diodes are far too resistive to provide robust ESD protection. For this reason, it is common to place separate STI diodes 26, 28, 32 and 34 in a region of the I/O cell separate from, but wired in parallel with, the diodes parasitic to the output buffers. These standalone ESD diodes typically occupy a significant layout area in order to conduct the majority of the ESD current while minimizing their on-resistance. The voltage drop across these diodes during ESD events adds to the total pad-to-pad stress voltage and is proportional to the on-resistance of the diodes. Therefore, there is a need to reduce the required I/O pad cell area while maintaining a relatively low-resistive ESD current path.

### BRIEF DESCRIPTION OF THE DRAWINGS

The present invention is illustrated by way of example and is not limited by the accompanying figures, in which like reference numbers indicate similar elements.

FIG. 1 illustrates in schematic diagram form a prior art ESD protection circuit.

FIG. 2 illustrates in schematic diagram form an ESD protection circuit in accordance with one embodiment of the present invention.

FIG. 3 illustrates a cross-sectional view of a PMOS output buffer transistor for use in the ESD protection circuit of FIG. 2.

FIG. 4 illustrates in schematic diagram form a distributed ESD protection circuit in accordance with another embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

Generally, the present invention provides an ESD protection circuit for the I/O pad cells of an IC. The ESD protection circuit uses parasitic drain-body diodes of the output buffer transistors as the primary, or dominant, ESD diodes. Specifically, the body tie diffusions of the output buffer transistors are butted to the source diffusions without an isolation region (STI) between the two diffusion regions (“butted source-body ties”). Utilizing parasitic drain-body diodes of output buffer transistors with butted source-body ties (“butted body tie diodes”) as the dominant ESD diodes eliminates the layout area required to implement separately placed STI diodes of the prior art circuit of FIG. 1.

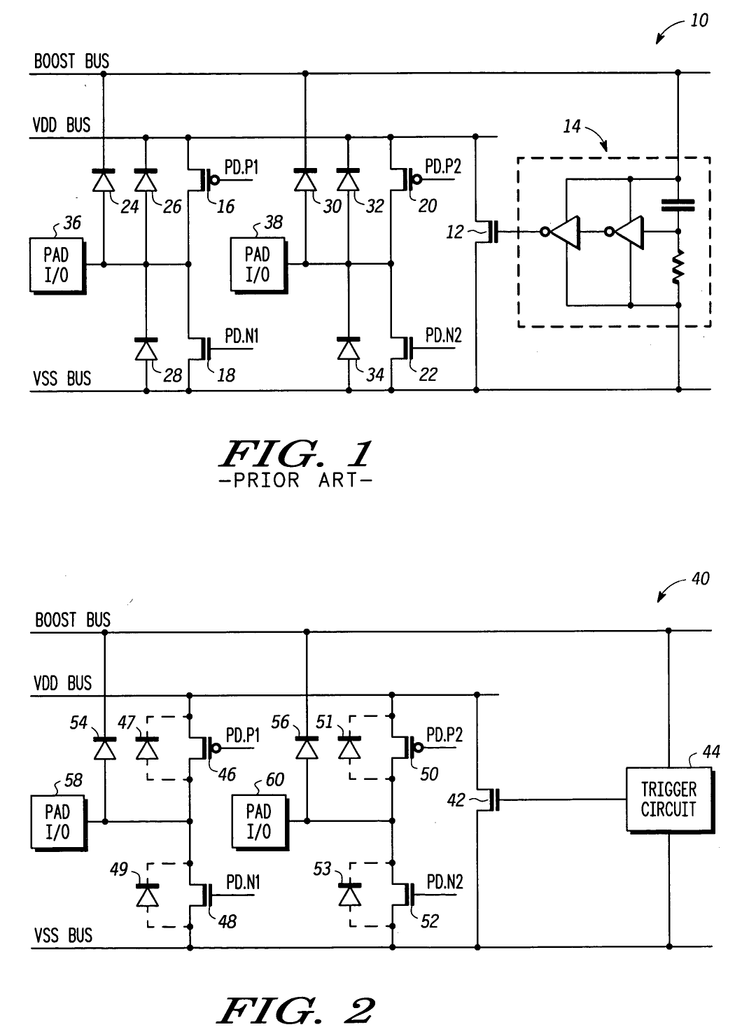

FIG. 2 illustrates in schematic diagram form an ESD protection circuit 40 in accordance with one embodiment of the present invention. ESD protection circuit 40 includes a first power supply bus labeled “VDD BUS”, a second power supply bus labeled “VSS BUS”, and a boosted voltage bus labeled “BOOST BUS”. In the illustrated embodiment, each of the buses comprises one or more metal conductors. In order to move the high currents associated with an ESD event, the VDD BUS and the VSS BUS are typically sized very large in order to minimize their resistance and the resulting IR voltage drops along their length. The BOOST BUS may be sized much smaller, due to the much smaller current typically coupled onto this bus during an ESD event. The VSS BUS may also be coupled to a silicon substrate (not shown) of the IC to allow the substrate to conduct in parallel with the metal VSS BUS.

A rail clamp device 42 has a first current electrode coupled to the VDD BUS and a second current electrode coupled to the VSS BUS. A trigger circuit is coupled between the BOOST BUS and the VSS BUS for receiving a voltage that is higher than the VDD BUS voltage during the ESD event. The trigger circuit 44 has an output coupled to a control electrode of the rail clamp device 42. The trigger circuit 44 detects an ESD event and in response, provides a bias voltage to the control electrode of the rail clamp device 42. In the illustrated embodiment, the rail clamp device 42 is an NMOS transistor. In other embodiments, the rail clamp device may be of a different type, for example, a PMOS transistor, a BJT (bipolar junction transistor), an SCR (silicon-controlled rectifier), or a GGMOS (grounded gate MOS) transistor. Also, in one embodiment, the trigger circuit 44 may comprise circuitry similar to the circuitry of trigger circuit 14 of FIG. 1. The trigger circuit 14 shows an RC stage coupled to the input of two series-connected inverters as one possibility. However, the specific circuit elements of trigger circuit 44 are not important for purposes of describing the invention and may be different in other embodiments. In addition, in the illustrated embodiment the I/O pads are coupled to circuits for both inputting and outputting signals. However in other embodiments, the I/O pads may be replaced with output pads coupled only to output circuitry, or replaced with input pads coupled only to input circuitry.

A PMOS output buffer transistor 46 has a first current electrode coupled to the VDD BUS, a second current electrode coupled to an I/O pad 58, and a control electrode for receiving a predriver signal labeled “PD.P1” from a predriver circuit (not shown). An NMOS output buffer transistor 48 has a first current electrode coupled to the I/O pad 58, a second current electrode coupled to the VSS BUS, and a control electrode for receiving a predriver signal labeled “PD.N1”. A PMOS output buffer transistor 50 has a first current electrode coupled to the VDD BUS, a second current electrode coupled to an I/O pad 60, and a control electrode for receiving a predriver signal labeled “PD.P2” from a predriver circuit (not shown). An NMOS transistor 52 has a first current electrode coupled to the I/O pad 60, a second current electrode coupled to the VSS BUS, and a control electrode for receiving a predriver signal labeled “PD.N2”. The output buffer transistors 46, 48, 50, and 52 include butted source-body ties. Each of the output buffer transistors has an associated parasitic drain-body diode as indicated in FIG. 2 by dashed lines. Transistors 46, 48, 50, and 52 have associated with them, parasitic diodes 47, 49, 51, and 53, respectively. The parasitic drain-body diode 47 of the transistor 46 is used to replace, for example, the standalone diode 26 of FIG. 1, and provides a primary current path during ESD events. Likewise, transistor 48 also has a parasitic drain-body diode 49 that replaces, for example, the ESD diode 28 of FIG. 1. A diode 54 has a first terminal coupled to the BOOST BUS and a second terminal coupled to the I/O pad 58. A diode 56 couples I/O pad 60 to the BOOST BUS. Diodes 54 and 56 may be implemented in a much smaller layout area than parasitic diodes 47, 49, 51, or 53 because they are not part of the primary ESD discharge path, but only provide an elevated voltage to the BOOST BUS.

When the IC is powered up and operating normally, trigger circuit 44 provides a bias to the gate of rail clamp device 42 that is equal to the VSS voltage to ensure that rail clamp device 42 is not conductive. When an ESD event is detected that causes the rail clamp device 42 to become conductive, the rail clamp device provides a low-resistive high-current path between the VDD BUS and the VSS BUS, and trigger circuit 44 provides a bias to the gate of transistor 42 that is equal to the voltage on the BOOST BUS.

By way of example, when a positive ESD voltage is applied to I/O pad 58 with respect to I/O pad 60, the intended high current ESD path is from pad 58 through parasitic diode 47 to the VDD BUS local to pad 58. Then the current flows along the VDD BUS, through rail clamp device 42 to the VSS BUS, along the VSS BUS, and through the parasitic drain-body diode 53 to I/O pad 60. During a typical ESD event, the peak current between pad 58 and pad 60 may be as high as 4 Amperes or higher.

While only I/O pads 58 and 60 are illustrated in FIG. 2 with their corresponding ESD protection circuits, there may be more than two I/O pads distributed along the BOOST BUS, VDD BUS, and VSS BUS as illustrated in FIG. 4 which will be described later. When multiple I/O pads are present, one trigger circuit and rail clamp, such as for example, trigger circuit 44 and rail clamp circuit 42 may protect this plurality of I/O pads. In other embodiments, multiple trigger circuits 44 and rail clamp devices 42 may be placed along the three buses to protect one or more I/O pads.

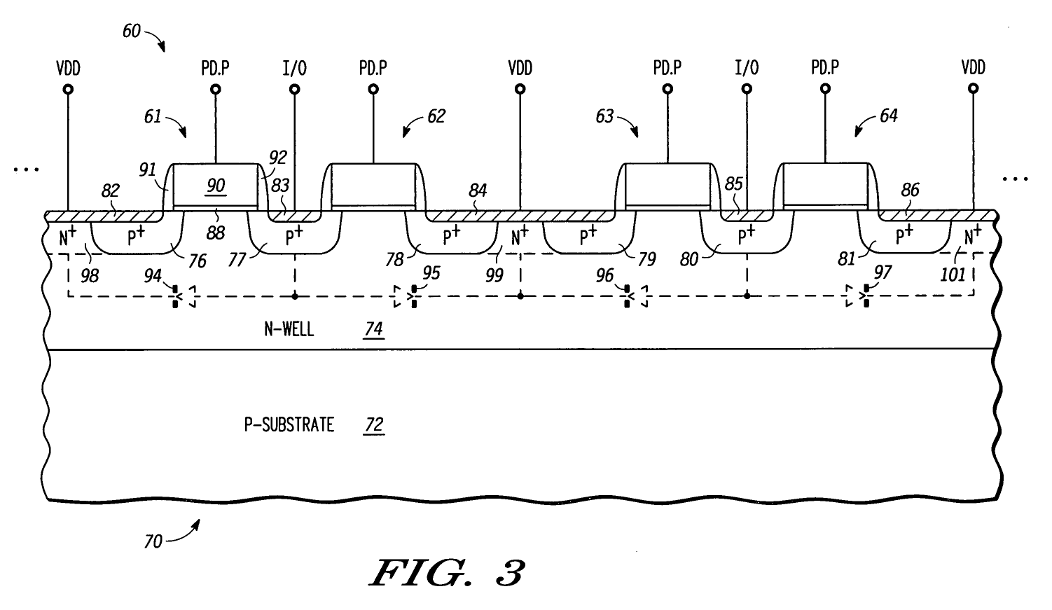

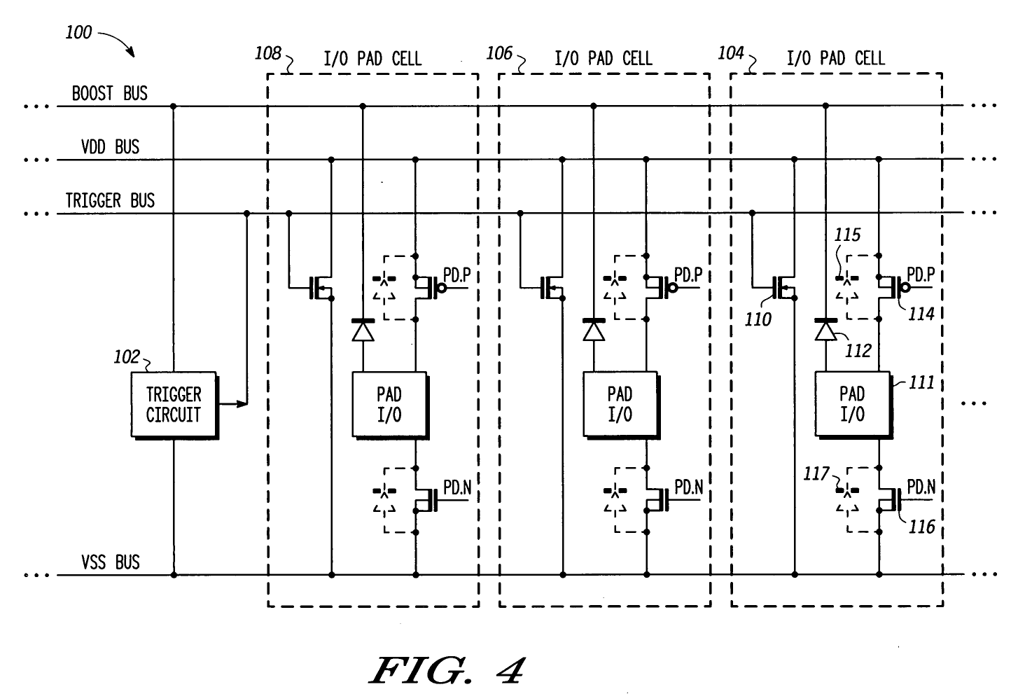

By using butted source-body ties in the output buffer transistors, parasitic diodes of the output buffer transistors are used as the main ESD protection diodes instead of separate ESD protection diodes. They can provide significantly higher failure current and significantly higher conductivity as compared to, for example, STI bounded diodes with an equal P-N junction perimeter, due primarily to the fact that the ESD current need not flow under any STI, but may flow much less impeded, along the silicon surface, as shown in FIG. 3, which will be described later. Also, the butted body tie diodes reduce capacitive loading on the I/O pad because there are no added diffusion regions tied to the pad, as would be the case for separately placed STI diodes. In addition, using butted source-body ties in the output buffer transistors provides the benefit of improved latch-up immunity.

FIG. 3 illustrates a cross-sectional view of a PMOS output buffer transistor 60 for use in the ESD protection circuit 40 of FIG. 2. PMOS output buffer transistor 60 is made up of a plurality of parallel-connected butted source-body tie transistors 61, 62, 63, and 64 implemented in an IC 70. IC 70 includes an N-well 74 formed in a P-substrate 72. The transistors 61-64 are formed in the N-well 74. Each of the transistors 61-64 has a first current electrode coupled to VDD, a second current electrode coupled to an I/O pad, and a gate coupled to receive predriver signal PD.P. More specifically, by way of example, transistor 61 has a P+ source region 76, a P+ drain region 77, and a gate 90 formed over a gate oxide 88. P+ drain region 77 forms the drains for both transistors 61 and 62. A silicide layer 82 is used to couple the source region 76 to VDD and a silicide layer 83 is used to couple the drain region 77 to the I/O pad. Gate 90 is formed from polysilicon and includes side-wall spacers 91 and 92. Each of the gates of transistors 62-64 are formed in the same way as the gate of transistor 61. Transistor 62 has a source region formed from the P+ diffusion region 78 and is coupled to VDD via silicide layer 84. Note that in the illustrated embodiment, VDD is a positive power supply voltage. Transistor 63 includes a P+ source region 79 coupled to the silicide layer 84, and a P+ drain region 80. P+ drain region 80 is coupled to the I/O pad via silicide layer 85 and also forms the drain of transistor 64. P+ region 81 forms the source of transistor 64 and is coupled to VDD via silicide layer 86. The PMOS output buffer transistor 60 includes multiple body ties that connect the N-well 74 to VDD. An N+ diffusion region 98 provides a body tie for transistor 61 and is butted to the P+ source region 76 and coupled to VDD by silicide layer 82. An N+ diffusion region 99 provides a body tie for transistors 62 and 63 and is butted to the P+ source regions 78 and 79 and coupled to VDD by silicide layer 84. An N+ diffusion region 101 provides a body tie for transistor 64 and is butted to the P+ source region 81 and coupled to VDD by silicide layer 86. Parasitic diodes are associated with each of the transistors 61-64 as illustrated in FIG. 3 with dashed lines. These parasitic diodes 94-97 are formed by P-N junctions between the N-well 74 and the P+ diffusion regions 77 and 80 that function as drains for each of the butted source-body tie output buffer transistors 61-64, respectively. By way of example, parasitic diode 94 provides an ESD current path from the I/O connection to VDD, wherein the current flows through silicide layer 83 to P+ drain region 77, crosses the P-N junction formed by P+ drain region 77 and N-well 74, continues to flow in the N-well to the N+ body tie diffusion 98, and then flows through silicide layer 82 to VDD. Note that there is no STI region that the current has to cross, which would force the current to penetrate deeper into the N-well and thereby increase the total diode resistance.

Note that FIG. 3 depicts four parallel connected transistors; however, the number of parallel connected transistors may be different in actual integrated circuit implementations. In one embodiment, the output buffer transistors are implemented in layout with a plurality of relatively small parallel connected transistors in a multi gate finger configuration, as opposed to one long gate finger, thereby providing an area efficient output buffer transistor layout. If all of the available parallel transistors are not required to achieve the required signal drive strength on the output pad, some of the gate fingers can be “optioned-out” by connecting them to VDD. However, the parasitic drain-body diodes associated with the optioned-out gate fingers will still be active and participate in the ESD current conduction.

Even though FIG. 3 shows a cross-section of a PMOS output buffer transistor, those skilled in the art will realize that an NMOS output buffer transistor can be easily made by, for example, forming the transistors in a P-substrate without an N-well, reversing the conductivity type of the diffusion regions, and replacing VDD by VSS.

FIG. 4 illustrates in schematic diagram form a distributed ESD protection circuit 100 in accordance with another embodiment of the present invention. The distributed ESD protection circuit 100 includes a trigger circuit 102 having a first terminal coupled to a boosted voltage bus labeled “BOOST BUS”, a second terminal coupled to a power supply conductor labeled “VSS BUS”, and a third terminal coupled to a bus labeled “TRIGGER BUS”. In response to detecting an ESD event, the trigger circuit 102 provides a control signal to the control terminals of the rail clamps in a plurality of I/O pad cells represented by I/O pad cells 104, 106, and 108. In one embodiment, the trigger circuit 102 is similar to the trigger circuit 14 of FIG. 1. Note that only one trigger circuit 102 is illustrated in FIG. 4, however, in other embodiments, there may be more than one trigger circuits. Each of the I/O pad cells are the same and includes a pad 111, an active rail clamp device 110 coupled between a bus labeled “VDD BUS” and the VSS BUS, a diode 112, a PMOS output buffer transistor 114 having a parasitic ESD protection diode 115, and an NMOS output buffer transistor 116 having a parasitic ESD protection diode 117. The distributed ESD protection circuit 100 of FIG. 4 functions in a similar way than ESD protection circuit 40 of FIG. 2; the multiple clamp devices 110 of FIG. 4, as part of each of the I/O pad cells 104, 106, and 108, work in parallel during an ESD event. The trigger circuit 102 drives the gates of the clamp devices via the TRIGGER BUS. The plurality of I/O pad cells with their clamp devices 110 is distributed across an IC as necessary to provide adequate ESD protection for a plurality of I/O pads. By distributing small rail clamp devices 110 of FIG. 4 over the I/O pad cells as compared to placing a large remote clamp device 42 of FIG. 2 to protect a plurality of I/O pads, a uniform ESD protection level can be achieved that is independent of the zapped and grounded I/O pad location. For the ESD protection circuit 40 of FIG. 2, assuming a plurality of I/O pads, the ESD protection level depends on the distance of the zapped and grounded I/O pads from the clamp device 42 because the IR drops along the VDD BUS and the VSS BUS caused by the relatively large ESD current adds to the total ESD stress voltage.

In some embodiments of the present invention, separate standalone ESD diodes (not shown in FIG. 2 or FIG. 4) may be placed in parallel with the parasitic butted tie diodes 47, 49, 51, and 53 (in FIG. 2) or diodes 115 and 117 (in FIG. 4). However, the parasitic butted tie diodes would still serve as the primary ESD diodes, conducting a majority of the ESD current. In another embodiment, the BOOST BUS shown in FIG. 2 and FIG. 4 may be shorted to the VDD BUS. This would eliminate the need for the small diodes 54 and 56 in FIG. 2, and diode 112 in FIG. 4. The trigger circuit would then be powered by the VDD BUS during an ESD event. However, the benefit from boosting the gate voltage of rail clamp devices 42 (FIG. 2) and 110 (FIG. 4) would be lost. Further, in the illustrated embodiment, butted source-body tie transistors are used for both the pull-up and pull-down output transistors. In other embodiments, only one of the pull-up and the pull-down transistors is a butted source-body tie transistor and the other is not a butted source-body tie transistor. In another embodiment, either the pull-up or the pull-down transistor may be replaced by other circuitry, for example a resistor, in which case a standalone ESD diode may be used instead of the butted body tie diode of the replaced transistor.

By now it should be appreciated that there has been provided an ESD protection circuit that may be used for pad cell protection for all types of integrated circuits. Also, the ESD protection circuits described herein are scalable to smaller processing geometries.

Because the apparatus implementing the present invention is, for the most part, composed of electronic components and circuits known to those skilled in the art, circuit details have not been explained in any greater extent than that considered necessary as illustrated above, for the understanding and appreciation of the underlying concepts of the present invention and in order not to obfuscate or distract from the teachings of the present invention.

In the foregoing specification, the invention has been described with reference to specific embodiments. However, one of ordinary skill in the art appreciates that various modifications and changes can be made without departing from the scope of the present invention as set forth in the claims below. For example, the transistors described herein may be implemented in any processing technology. For the MOS transistors illustrated, changing the conductivity type and the associated signaling logic are changes that are readily apparent. In certain situations, parasitic diodes that exist naturally may be used rather than implementing discrete diodes. Also, the physical positioning of the trigger circuits, pull-up circuitry and diodes within and around the pad cells may be varied from that illustrated without the functionality of the circuitry being affected. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms a or an, as used herein, are defined as one or more than one. The term plurality, as used herein, is defined as two or more than two. The term another, as used herein, is defined as at least a second or more. The terms “including” and/or “having”, as used herein, are defined as “comprising” (i.e., open language). The term “coupled”, as used herein, is defined as connected, although not necessarily directly, and not necessarily mechanically.

What is claimed is:

1. An integrated circuit comprising:
a first power supply conductor;
a second power supply conductor;
a rail clamp device, coupled between the first and second power supply conductors, for providing a current path between the first and second power supply conductors during an electrostatic discharge (ESD) event;
an output pad; and
an output buffer transistor having a butted source-body tie, the output buffer transistor coupled between the output pad and the first power supply conductor, wherein a parasitic diode associated with the output buffer transistor provides a primary ESD current path between the first power supply conductor and the output pad.

2. The integrated circuit of claim 1, further comprising a second output buffer transistor coupled between the second power supply conductor and the output pad, the second output buffer transistor having a butted source-body tie, wherein a parasitic diode associated with the second output buffer transistor provides a primary ESD current path between the second power supply conductor and the output pad.

3. The integrated circuit of claim 2, wherein the second output buffer transistor is characterized as being a PMOS transistor and the output buffer transistor is characterized as being an NMOS transistor.

4. The integrated circuit of claim 1, wherein the output buffer transistor is implemented as a plurality of parallel connected butted source-body tie output buffer transistors, wherein each of the plurality of parallel connected butted source-body tie output buffer transistors comprises a parasitic diode for conducting ESD current, and wherein the parasitic diodes of all of the plurality of parallel connected butted source-body tie output buffer transistors conduct the ESD current if less than all of the plurality of parallel connected butted source-body tie output buffer transistors are used to drive a signal on the output pad.

5. The integrated circuit of claim 1, wherein the parasitic diode associated with the output buffer transistor is formed by a P-N junction between an N-well and a P+ diffusion region that functions as a drain of the output buffer transistor.

6. The integrated circuit of claim 1, wherein the parasitic diode associated with the output buffer transistor is formed by a P-N junction between a P-substrate and an N+ diffusion region that functions as a drain of the output buffer transistor.

7. The integrated circuit of claim 1, further comprising:
a trigger circuit having an output coupled to a control electrode of the rail clamp device, the trigger circuit for providing a bias voltage to the control electrode in response to detecting the ESD event.

8. The integrated circuit of claim 7, further comprising:
a boost conductor; and
a diode coupled between the output pad and the boost conductor;
the trigger circuit coupled to the boost conductor for receiving a voltage higher than the voltage provided to the first and second power supply conductor during the ESD event.

9. The integrated circuit of claim 7, further comprising:
a plurality of output pads;
a plurality of butted source-body tie output buffer transistors, a butted source-body tie output buffer transistor of the plurality of butted source-body tie output buffer transistors coupled to a corresponding one of the plurality of output pads; and
a plurality of rail clamp devices, one of the plurality of rail clamp devices associated with one of the plurality of output pads, wherein control electrodes of each of the plurality of rail clamp devices are coupled to the output of the trigger circuit.

10. An integrated circuit comprising:
a first power supply conductor;
a second power supply conductor;
a plurality of output pads;
a plurality of output buffer transistors, each of the plurality having a butted source-body tie and coupled between one of the plurality of output pads and the first power supply conductor, wherein a parasitic diode associated with each of the plurality of output buffer transistors provides a primary ESD current path between the first power supply conductor and the output pad;
a plurality of rail clamp devices, each of the plurality of rail clamp devices coupled between the first and second power supply conductors and associated with one of the plurality of output pads, for providing current paths between the first and second power supply conductors during an electrostatic discharge (ESD) event; and
a trigger circuit having an output coupled to a control electrode of each of the plurality of rail clamp devices, the trigger circuit for providing a bias voltage to the control electrodes in response to detecting the ESD event.

11. The integrated circuit of claim 10, further comprising a second plurality of output buffer transistors coupled between the second power supply conductor and the output pad, each of the second plurality of output buffer transistors having a butted source-body tie, wherein a parasitic diode associated with each of the second plurality of output buffer transistors provides a primary ESD current path between the second power supply conductor and the output pad.

12. The integrated circuit of claim 11, wherein the plurality of output buffer transistors are characterized as being NMOS transistors and the second plurality of output buffer transistors are characterized as being PMOS transistors.

13. The integrated circuit of claim 11, wherein each of the plurality of output buffer transistors is implemented as a plurality of parallel connected butted source-body tie output buffer transistors, wherein each of the plurality of parallel connected butted source-body tie output buffer transistors comprises a parasitic diode for conducting ESD current, and wherein the parasitic diodes of all of the plurality of parallel connected butted source-body tie output buffer transistors conduct the ESD current if less than all of the plurality of parallel connected butted source-body tie output buffer transistors are used to drive a signal on one of the plurality of output pads.

14. The integrated circuit of claim 10, further comprising:
a boost conductor;
a plurality of diodes, a diode of the plurality of diodes coupled between one of the plurality of output pads and the boost conductor; and
the trigger circuit coupled to the boost conductor for receiving a voltage higher than a power supply voltage provided to the first and second power supply conductors during the ESD event.

15. The integrated circuit of claim 10, wherein the parasitic diode associated with each of the plurality of output buffer transistors is formed by a P-N junction between an N-well and a P+ diffusion region that functions as a drain of one of the plurality of output buffer transistors.

16. The integrated circuit of claim 10, wherein the parasitic diode associated with each of the plurality of output buffer transistors is formed by a P-N junction between a P-substrate and an N+ diffusion region that functions as a drain of one of the plurality of output buffer transistors.
